(19) United States
(12) Patent Application Publication
(10) Pub. No.: US 2019/0386515 A1
(43) Pub. Date: Dec. 19, 2019

(54) WIRELESS CHARGING DEVICE

(71) Applicant: LG INNOTEK CO., LTD., Seoul (KR)

(72) Inventor: Sung Hyun LEEM, Seoul (KR)

(73) Assignee: LG INNOTEK CO., LTD., Seoul (KR)

(21) Appl. No.: 16/489,659

(22) PCT Filed: Feb. 2, 2018
(86) PCT No.: PCT/KR2018/001443

§ 371 Date: Aug. 28, 2019

(30) Foreign Application Priority Data
Mar. 14, 2017 (KR) 10-2017-0031965
Apr. 26, 2017 (KR) 10-2017-0053509
May 15, 2017 (KR) 10-2017-0059938

(51) Int. Cl. H02J 50/10; H01F 27/30; H01F 27/36

(52) U.S. Cl. CPC H02J 50/10; H01F 38/14; H01F 27/36; H01F 27/30

(57) ABSTRACT

The present invention relates to a wireless charging device. A wireless charging device, according to one embodiment of the present invention, comprises: a coil assembly; a first substrate disposed on the coil assembly; an electromagnetic interference (EMI) filter disposed on a first surface of the first substrate; and a wireless communications antenna disposed on a second surface of the first substrate, wherein the coil assembly includes a plurality of coils, and the EMI filter can include a plurality of different pattern regions corresponding to the plurality of coils. Therefore, the wireless charging device having the EMI filter can be provided.

### TECHNICAL FIELD

Embodiments relate to wireless charging technology and, more particularly, a wireless charging device that is included in an electromagnetic interference (EMI) filter and blocks unnecessary electromagnetic waves generated during wireless charging.

### BACKGROUND ART

In general, an example of an electrical connection mode between a battery and a charging device for charging the battery with power includes a terminal supply mode of receiving commercial power, converting the commercial power into voltage and current corresponding to the battery, and supplying electrical energy to the battery through a terminal of the corresponding battery. The terminal supply mode is accompanied by use of a physical cable or wiring. Accordingly, when many apparatuses of the terminal supply mode are used, a significant working space is occupied by many cables, it is difficult to organize the cables, and an outer appearance is achieved. In addition, the terminal supply mode causes problems such as an instantaneous discharge phenomenon due to different potential differences between terminals, damage and fire due to impurities, natural discharge, and degradation in lifespan and performance of a battery.

Recently, to overcome the problems, a charging system (hereinafter, referred to as a “wireless charging system”) and control methods using a mode of wirelessly transmitting power have been proposed. In the past, a wireless charging system is not basically installed in some terminals and a consumer needs to purchase a separate accessory of a wireless charging receiver and, thus, a demand for a wireless charging system is low, but users of wireless charging are expected to be remarkably increased and, in the future, a terminal manufacturer is also expected to basically install a wireless charging function.

Wireless power transmission or wireless energy transfer refers to technology for wirelessly transmitting electric energy from a transmitter to a receiver using the magnetic induction principle. In 1800s, electric motors or transformers using the electromagnetic induction principle have begun to be used and, thereafter, attempts have been made to radiate electromagnetic waves such as radio waves, lasers, high frequencies or microwaves to transfer electric energy. Frequently used electric toothbrushes or some wireless shavers are charged using the electromagnetic induction principle.

In general, a wireless charging system includes a wireless power transmitter that supplies energy electrical energy in a wireless power transmission mode and a wireless power receiver that receives electrical energy supplied from the wireless power transmitter and charges a battery with the electrical energy.

Up to now, a wireless energy transfer method may be roughly divided into a magnetic induction method, an electromagnetic resonance method and a radio frequency (RF) transmission method of a short-wavelength radio frequency.

For example, the wireless power transmission mode may use various wireless power transmission standards based on an electromagnetic induction mode for performing charging using an electromagnetic induction principle whereby a power transmission end coil generates a magnetic field to induce electricity in a reception end coil by the influence of the magnetic field. Here, the wireless power transmission standard of the electromagnetic induction mode may include a wireless charging technology of an electromagnetic induction mode in the wireless power consortium (WPC) and/or the power matters alliance (PMA).

As another example, the wireless power transmission mode may use an electromagnetic resonance mode for transmitting power to a wireless power receiver positioned at a short distance via synchronization between a magnetic field generated by a transmission coil of a wireless power transmitter and a specific resonance frequency. Here, the electromagnetic resonance mode may include a wireless charging technology defined in the alliance for the wireless power (A4WP) standard institute that is a wireless charging technology standard institute.

The magnetic induction method uses a phenomenon that, when two coils are located adjacent to each other and then current is applied to one coil, a magnetic flux is generated to cause an electromotive force in the other coil, and is rapidly being commercialized in small devices such as mobile phones. The magnetic induction method may transfer power of up to several hundred kilowatts (kW) and has high efficiency. However, since a maximum transmission distance is 1 centimeter (cm) or less, a device to be charged should be located adjacent to a charger or the floor.

The electromagnetic resonance method uses an electric field or a magnetic field instead of using electromagnetic waves or current. The electromagnetic resonance method is rarely influenced by electromagnetic waves and thus is advantageously safe for other electronic devices and human. In contrast, this method may be used in a limited distance and space and energy transmission efficiency is somewhat low.

The short-wavelength wireless power transmission method (briefly referred to as the RF transmission method) takes advantage of the fact that energy may be directly transmitted and received in the form of radio waves. This technology is an RF wireless power transmission method using a rectenna. A rectenna is a combination of an antenna and a rectifier and means an element for directly converting RF power into DC power. That is, the RF method is technology for converting AC radio waves into DC. Recently, as efficiency of the RF method has been improved, studies into commercialization of the RF method have been actively conducted.

Wireless power transmission technology may be used not only in mobile related industries but also in various industries such as IT, railroads and home appliances.

Like wireless charging, an apparatus using an electromagnetic field restrictedly emits electromagnetic waves with a predetermined amplitude or grater due to regulation of electromagnetic interference (EMI).

Korean Patent Application No. 10-2013-7033209 (Receiver for Wireless Power Reception and Wireless Power Receiving Method thereof) discloses a receiver for a wireless charging system including a coil for receiving power energy and a near field communication (NFC) that is separately configured outside the coil.

A wireless power transmitter includes both a wireless power transmitter antenna and a short-distance wireless communication antenna, and in this case, signals transmitted and received by each of the antennas may act as electromagnetic interference (EMI) therebetween. In general, wireless power signal having relatively high power may affect short-distance wireless communication as an obstructive factor.

Accordingly, there is a need for a method of alleviating influence of communications disruption on an short-distance wireless communication antenna due to the.

The wireless power transmitter generates an alternating current (AC) power signal with a specific operation frequency and wirelessly transmits the generated AC power signal through a transmission coil.

In this case, the wireless power transmitter may generate not only a signal in a desired operation frequency band but also harmonic signals in other bands.

There is a problem in that such a harmonic signal affects an operation of other electronic devices in the vicinity of the wireless power transmitter.

For example, a wireless power transmitter may be installed in a vehicle. In this case, a harmonic component generated by the wireless power transmitter may act as an interference component in reception of radio elective wave of a vehicle.

Accordingly, it is very important to block remaining unnecessary frequency components except for an operation frequency band used in wireless charging.

### DISCLOSURE

### Technical Problem

Embodiments provide a wireless power transmitter including an electromagnetic interference (EMI) filter.

Embodiments provide a wireless power transmitter including an EMI filter that is integrated into a near field communication (NFC) antenna on a single substrate and blocks an unnecessary electromagnetic field.

Embodiments provide a wireless power transmitter including a short-distance wireless communication antenna.

Embodiments provide a wireless power transmitter including an EMI filter for blocking a harmonic signal of a wireless power signal that affects a short-distance wireless communication antenna.

The technical problems solved by the embodiments are not limited to the above technical problems and other technical problems which are not described herein will become apparent to those skilled in the art from the following description.

### Technical Solution

Embodiments provide a wireless power transmitter including an electromagnetic interference (EMI) filter.

In an embodiment, a wireless power transmitter according to an embodiment may include a charging bed, a transmission coil assembly, an antenna substrate disposed between the charging bed and the transmission coil assembly and including a short-distance wireless communication antenna and an electromagnetic interference filter, and a control circuit board connected to the transmission coil assembly and the antenna substrate and controlling short-distance wireless communication and wireless charging.

The electromagnetic interference filter may be disposed on a first surface of the antenna substrate, and the short-distance wireless communication antenna may be disposed on a second surface of the antenna substrate.

The electromagnetic interference filter may be disposed inside the short-distance wireless communication antenna not to overlap the short-distance wireless communication antenna.

The transmission coil assembly may include a plurality of transmission coils with a step difference, and a shape of the electromagnetic interference filter may be determined based on the step difference.

The electromagnetic interference filter may include a first wiring connected to a ground terminal and a plurality of pattern filters branched from the first wiring, and slits directions of the pattern filter may be changed according to the step difference.

Slit directions of the pattern filter may be orthogonal to each other according to the step difference.

The plurality of transmission coils and the short-distance wireless communication antenna may be disposed not to overlap each other.

The short-distance wireless communication antenna may be a near field communication (NFC) antenna.

The NFC antenna is shaped like a loop, and one end and the other end of the loop may be connected to negative and positive signal terminals disposed on the first surface through first and second through holes or via holes included in the antenna substrate.

The loop may have a plurality of turns, and the plurality of turns may cross each other through the first surface in a partial section of the loop.

A terminal branched from one side of the outermost turn of the loop may be connected to a ground terminal disposed on the first surface through the third through hole or via hole included in the antenna substrate.

The first surface may face the charging bed, and the second surface may face the transmission coil assembly.

The electromagnetic interference filter may block a signal with a frequency band that exceeds an operation frequency band for wireless charging.

In another embodiment, a wireless charging device may be provided.

The wireless charging device may include a coil assembly, a first substrate disposed on the coil assembly, an electromagnetic interference filter disposed on a first surface of the first substrate, and a wireless communication antenna disposed on a second surface of the first substrate, wherein the coil assembly may include a plurality of coils, and the electromagnetic interference filter may include a plurality of pattern regions corresponding to the plurality of coils, respectively.

The coil assembly may include a first coil, a second coil, and a third coil, the first coil and the second coil may be disposed on a second substrate, the third coil may be disposed on the first coil and the second coil, and the plurality of different pattern regions may include a first pattern region corresponding to the first coil or the second coil and a second pattern region corresponding to the third coil.

The electromagnetic interference filter may include a first wiring disposed in a loop shape on the second surface.

The first pattern region may be connected through first connection structures positioned in opposite regions of the first wiring, and the second pattern region may be connected through a second connection structure positioned in a central region of the first wiring.

The first connection structure may be configured in a plural number.

The first pattern region may include a second connection wiring connected to the first connection structure, the second pattern region may include a third connection wiring connected to the second connection structure, and the third connection wiring may have a smaller width than the first wiring or the second connection wiring.

The first pattern region may include a first slit structure disposed in a first direction in the second connection wiring, and the second pattern region may include a second slit structure disposed in a second direction in the third connection wiring.

The first direction and the second direction may be different from each other.

The first direction and the second direction may be orthogonal to each other.

The first pattern region may be disposed to be spaced apart from the first coil or the second coil, and the second pattern region may be disposed to contact the third coil.

The first pattern region and the second pattern region may have different inductance values.

The first pattern region may have a smaller area than an area of a portion on which the first coil or the second coil is disposed.

The second pattern region may have a larger area than an area of a portion on which the third coil is disposed.

The first pattern region and the second pattern region may have different areas.

The first pattern region and the second pattern region may have different shapes.

The second pattern region may be disposed between the first pattern regions.

A spaced unit may be disposed between the first pattern region and the second pattern region.

A spaced unit may be disposed between the first pattern region and the second pattern region.

The second connection wiring may be shaped like a straight line, and the third connection wiring may be shaped like a curve shape.

The first slit structure may include a plurality of spaced wirings, and the plurality of spaced wirings may have different lengths.

The second slit structure may include a plurality of spaced wirings, and the plurality of spaced wirings may have different lengths.

The first connection structure may have a smaller width than a width of the second connection structure.

In another embodiment, a wireless power transmitter includes a wireless power transmitter antenna configured to transmit a wireless power signal in a first operation frequency band, a short-distance wireless communication antenna configured to transmit and receive a short-distance wireless communication signal in a short operation frequency band, and an electromagnetic interference filter configured to block the first operation frequency band, wherein the electromagnetic interference filter includes a first filter configured to pass a signal with a first cut-off frequency or greater, and a second filter configured to pass a signal with a second cut-off frequency or less.

In some embodiments, the first filter may include a first antenna with a first pattern, and the second filter may include a second antenna with a second pattern.

In some embodiments, the first antenna may have a first determined based on the first cut-off frequency, and the second antenna may have a second length determined based on the second cut-off frequency.

In some embodiments, slit directions of the first pattern and the second pattern may be orthogonal to each other.

In some embodiments, the first antenna and the second antenna may not overlap each other and may be stacked on different layers.

In some embodiments, the wireless power transmitter antenna and the short-distance wireless communication antenna may be spaced apart from each other on the same plane.

In some embodiments, the first antenna and the second antenna may be disposed to be spaced apart from each other on the same plane as the short-distance wireless communication antenna.

In some embodiments, the first antenna may be positioned outside the short-distance communication antenna and may be disposed to surround the short-distance communication antenna, and the second antenna may be positioned inside the short-distance communication antenna and may be disposed to be surrounded by the short-distance communication antenna.

In some embodiments, the wireless power transmitter antenna may be disposed on different layers to overlap at least one of the first antenna and the second antenna.

The aspects of the disclosure are only a part of the preferred embodiments of the disclosure, and various embodiments based on technical features of the disclosure may be devised and understood by the person with ordinary skill in the art based on the detailed description of the disclosure.

### Advantageous Effects

The effects of methods and devices according to embodiments are as follows.

Embodiments provide a wireless power transmitter including an electromagnetic interference (EMI) filter.

Embodiments provide a wireless power transmitter including an EMI filter that is integrated into a near field communication (NFC) antenna on a single substrate, thereby enhancing process efficiency and reducing material costs.

Embodiments provide a wireless power transmitter in which an EMI filter and an NFC antenna are disposed on opposite surfaces of one substrate, thereby minimizing a product thickness.

Embodiments provide a wireless power transmitter for performing short-distance wireless communication, and thus a user may ensure a payment device using short-distance wireless communication.

Embodiments provide a wireless power transmitter for performing various functions such as vehicle starting, identification of a vehicle position, or user authentication or identification through short-distance wireless communication when a wireless power transmitter including a short-distance wireless communication antenna is installed in a vehicle.

The effects of the disclosure are not limited to the above-described effects and other effects which are not described herein may be derived by those skilled in the art from the following description of the embodiments of the disclosure. That is, effects which are not intended by the disclosure may be derived by those skilled in the art from the embodiments of the disclosure.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram illustrating a wireless charging system according to an embodiment;

FIG. 2 is a block diagram illustrating a wireless charging system according to another embodiment;

FIG. 3 is a diagram for explanation of a problem in terms of electromagnetic interference (EMI) that occurs during wireless charging in a vehicle;

FIG. 4 is an exploded perspective view of a wireless charging device (hereinafter, a wireless power transmitter) according to an embodiment;

FIG. 5 is a diagram for explanation of a structure of a first surface of an antenna substrate according to an embodiment;

FIG. 6 is a diagram for explanation of a structure of a second surface of an antenna substrate according to an embodiment;

FIG. 7 is a diagram for explanation of a structure of a connection terminal disposed on an antenna substrate according to an embodiment;

FIG. 8 is a diagram for explanation of a structure of a transmission coil assembly according to an embodiment;

FIG. 9 is a diagram showing a detailed structure of reference numeral 900 of FIG. 5;

FIG. 10 is a diagram showing a substrate on which an electromagnetic interference filter is installed according to the related art;

FIG. 11 is a graph showing an experimental result showing EMI shielding performance with respect to the electromagnetic interference filter of FIG. 10 above;

FIG. 12 is a graph showing EMI shield performance of the electromagnetic interference filter of FIG. 5 above;

FIGS. 13A to 13D are diagrams for explanation of arrangement of a wireless power transmitter antenna and a short-distance wireless communication antenna according to an embodiment;

FIG. 14 is a diagram for explanation of a harmonic of a wireless power signal and a frequency band of a short-distance wireless communication signal according to an embodiment;

FIG. 15 is a diagram for explanation of an electromagnetic interference filter according to an embodiment; and

FIG. 16 is a diagram for explanation of a matching circuit of an electromagnetic interference filter according to an embodiment.

### BEST MODEL

A wireless power transmitter according to an embodiment may include a charging bed, a transmission coil assembly, an antenna substrate disposed between the charging bed and the transmission coil assembly and including a short-distance wireless communication antenna and an electromagnetic interference filter, and a control circuit board connected to the transmission coil assembly and the antenna substrate and controlling short-distance wireless communication and wireless charging.

### MODE FOR INVENTION

Reference will now be made in detail to the exemplary embodiments, examples of which are illustrated in the accompanying drawings. The suffixes “module” and “unit” of elements herein are used for convenience of description and thus can be used interchangeably and do not have any distinguishable meanings or functions.

Although all elements constituting the embodiments are described as integrated into a single one or to be operated as a single one, the embodiments are not necessarily limited. According to embodiments, all of the elements may be selectively integrated into one or more and be operated as one or more within the object and the scope of the embodiments. Each of the elements may be implemented as independent hardware. Alternatively, some or all of the elements may be selectively combined into a computer program having a program module performing some or all functions combined in one or more pieces of hardware. A plurality of code and code segments constituting the computer program may be easily understood by those skilled in the art to which the embodiments pertain. The computer program may be stored in computer readable media such that the computer program is read and executed by a computer to implement embodiments. Computer program storage media may include magnetic recording media, and optical recording media.

In description of exemplary embodiments, it will be understood that, when an element is referred to as being “on” or “under” another element, the element can be directly on another element or intervening elements may be present. In addition, when an element is referred to as being “on” or “under” another element, this may include the meaning of an upward direction or a downward direction based on one component.

The term “comprises”, “includes”, or “has” described herein should be interpreted not to exclude other elements but to further include such other elements since the corresponding elements may be included unless mentioned otherwise. All terms including technical or scientific terms have the same meanings as generally understood by a person having ordinary skill in the art to which the embodiments pertain unless mentioned otherwise. Generally used terms, such as terms defined in a dictionary, should be interpreted to coincide with meanings of the related art from the context. Unless differently defined in the embodiments, such terms should not be interpreted in an ideal or excessively formal manner.

It will be understood that, although the terms first, second, A, B, (a), (b), etc. may be used herein to describe various elements of the embodiments, these terms are only used to distinguish one element from another element and essential, order, or sequence of corresponding elements are not limited by these terms. It will be understood that when one element is referred to as being “connected to”, “coupled to”, or “access” another element, one element may be “connected to”, “coupled to”, or “access” another element via a further element although one element may be directly connected to or directly access another element.

In the following description of the embodiments, a detailed description of known related art will be omitted when it is determined that the subject matter of the embodiments may be unnecessarily obscured.

In the description of embodiments, an apparatus for transmitting wireless power in a wireless power system may be used interchangeably with a wireless power transmitter, a wireless power transfer apparatus, a wireless electric power transfer apparatus, a wireless electric power transmitter, a transmission end, a transmitter, a transmission apparatus, a transmission side, a wireless power transfer apparatus, a wireless power transfer, etc., for convenience of description. An apparatus for receiving wireless power from a wireless power transfer apparatus may be used interchangeably with a wireless electric power reception apparatus, a wireless electric power receiver, a wireless power reception apparatus, a wireless power receiver, a reception terminal, a reception side, a reception apparatus, a receiver, etc.

The transmitter according to embodiment may be configured in the form of a pad, a cradle, an access point (AP), a small base station, a stand, a ceiling embedded structure, a floor-embedded structure or a wall-mounted structure. One transmitter may transfer wireless power to a plurality of wireless power reception apparatuses. To this end, the transmitter may include at least one wireless power transfer means. Here, the wireless power transfer means may use various wireless power transfer standards based on an electromagnetic induction method of performing charging using the electromagnetic induction principle in which a magnetic field is generated in a power transfer-end coil and electricity is induced in a reception-end coil by the magnetic field.

In addition, a receiver according to an embodiment may include at least one wireless power reception means and may simultaneously receive wireless power from two or more transmitters. The wireless power receiver according to an embodiment may be installed at one side of a transportation apparatus, but the embodiments are not limited thereto and any device may be used as long as the device includes the wireless power reception means installed therein and is chargeable using a battery.

Types and characteristics of a wireless power transmitter and a wireless power receiver according to the disclosure may each be classified according to their classes and categories.

The type and characteristics of the wireless power transmitter may be identified through the following three parameters.

First, the wireless power transmitter may be identified by a class determined according to maximum intensity of power applied to a resonance circuit.

Here, the class of the wireless power transmitter may be determined by comparing a maximum value of power P_{TX_IN_COIL} applied to the resonance circuit with maximum input power P_{TX_IN_MAX} that is obviously stated in the following class table (hereinafter, referred to as Table 1) of a wireless power transmitter and is predefined for each class. Here, P_{TX_IN_COIL} may be a real number value calculated by dividing a product of voltage (V(t)) and current (I(t)) applied to the resonance circuit per unit time by the corresponding unit time.

TABLE 1

| | | Minimum category | Maximum number of |
|---|---|---|---|
| | Maximum | support | supportable |
| Class | input power | requirements | devices |
| Class 1 | 2 W | 1 × Class 1 | 1 × Class 1 |
| Class 2 | 10 W | 1 × Class 3 | 2 × Class 2 |
| Class 3 | 16 W | 1 × Class 4 | 2 × Class 3 |
| Class 4 | 33 W | 1 × Class 5 | 3 × Class 3 |
| Class 5 | 50 W | 1 × Class 6 | 4 × Class 3 |
| Class 6 | 70 W | 1 × Class 6 | 5 × Class 3 |

Classes shown in Table 1 above are merely an embodiment, and thus a new class may be added or some classes may be removed. In addition, it is noted that values about maximum input power for each class, minimum category support requirements, and a maximum number of supportable devices may also be changed according to the use, shape, and embodied form of a wireless power transmitter.

For example, as shown in Table 1 above, when a maximum value of power P_{TX_IN_COIL} applied to the resonance circuit is equal to or greater than a value of P_{TX_IN_MAX} corresponding to class 3 and is smaller than a value of P_{TX_IN_MAX} corresponding to class 4, a class of a corresponding wireless power transmitter may be determined as class 3.

Second, the wireless power transmitter may be identified according to minimum category support requirements corresponding to an identified class.

Here, the minimum category support requirements may be the number of supportable wireless power receivers corresponding to a highest level category among categories of a wireless power receiver supportable by a corresponding level of wireless power transmitter. That is, the minimum category support requirements may be a minimum number of maximum category devices supportable by the corresponding wireless power transmitter. In this case, the wireless power transmitter may support all categories of wireless power receives corresponding to a maximum category or less according to the minimum category support requirements.

However, when a wireless power transmitter is capable of supporting a wireless power receiver of a higher category than a category obviously stated in the minimum category support requirements, the wireless power transmitter may not be restricted from supporting a corresponding wireless power receiver.

For example, as shown in Table 1 above, a wireless power transmitter of Class 3 needs to support at least one wireless power receiver of category 5. Needless to say, in this case, the wireless power transmitter may support the wireless power receiver corresponding to a lower category level than a category level corresponding to the minimum category support requirements.

In addition, it is noted that, when it is determined that the wireless power transmitter is capable of supporting a higher category level than a category corresponding to the minimum category support requirements, the wireless power transmitter may also support a wireless power receiver of a higher level.

Third, the wireless power transmitter may be identified by a maximum number of supportable devices corresponding to an identified class. Here, the maximum number of supportable devices may be identified by a maximum number of supportable wireless power receivers (hereinafter, referred to as a maximum number of supportable devices) corresponding to a lowest level category among supportable categories in a corresponding class.

For example, as shown in Table 1 above, a wireless power transmitter of class 3 needs to support a maximum of two wireless power receivers of a minimum category 3.

However, when the wireless power transmitter is capable of supporting a maximum number or more of devices corresponding to a class of the wireless power transmitter, a maximum number or more of devices may not be restricted from being supported.

The wireless power transmitter according to the disclosure needs to wirelessly transmit power up to at least the number defined in Table 1 within available power unless there is a special reason that does not permit a power transmission request of the wireless power receiver.

For example, when available power for accepting the corresponding power transmission request does not remain, the wireless power transmitter may not permit the power transmission request of the corresponding wireless power receiver. Alternatively, the wireless power transmitter may control power adjustment of the wireless power receiver.

As another example, when a power transmission request, if accepted, exceeds the number of acceptable wireless power receivers, the wireless power transmitter may not permit the corresponding power transmission request of the wireless power receiver.

As another example, when a category of a wireless power receiver that requests power transmission exceeds a category level supportable at a level of the wireless power receiver, the wireless power transmitter may not permit the corresponding power transmission request of the wireless power receiver.

As another example, when an inner temperature exceeds a reference value or more, a wireless power transmitter may not permit the corresponding power transmission request of the wireless power receiver.

Hereinafter, the type and characteristics of a wireless power receiver will be described.

Average output power PRXOUT of the receiver may be a real number value calculated by dividing a product of voltage (V(t)) and current (I(t)) output by the rectifier for a unit time by the corresponding unit time.

As shown in Table 2 below, a category of the wireless power receiver may be defined based on maximum output power P_{RX_OUT_MAX} of the rectifier.

TABLE 2

| | Maximum | |
|---|---|---|
| Category | input power | Application example |
| Category 1 | TBD | Bluetooth handset |
| Category 2 | 3.5 W | Feature phone |
| Category 3 | 6.5 W | Smartphone |
| Category 4 | 13 W | Tablet |
| Category 5 | 25 W | Small laptop |
| Category 6 | 37.5 W | Laptop |
| Category 6 | 50 W | TBD |

For example, when charging efficiency at a load end is 80% or more, a wireless power receiver of Category 3 may supply power of 5 W to a charging port of the load.

Categories shown in Tables 1 and 2 above may be merely an embodiment and a new category may be added or some classes may be removed. In addition, it is noted that examples of maximum output power for each category and application shown in Tables 1 and 2 above may also be modified according to the use, shape, and embodied form of the wireless power transmitter and the wireless power receiver as well as wireless charging standards applied thereto.

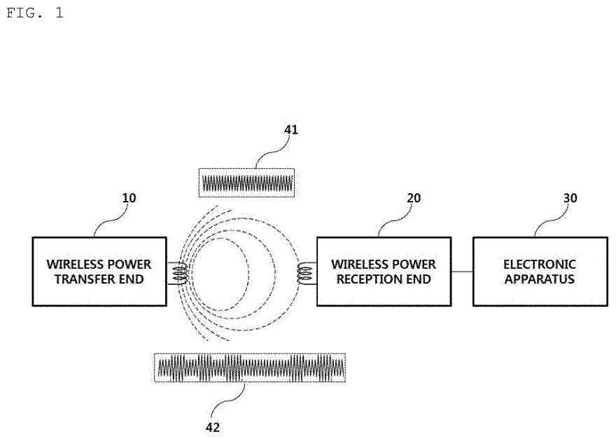

FIG. 1 is a block diagram illustrating a wireless charging system according to an embodiment.

Referring to FIG. 1, the wireless charging system roughly includes a wireless power transfer end 10 for wirelessly transmitting power, a wireless power reception end 20 for receiving the transmitted power and an electronic apparatus 30 for receiving the received power.

For example, the wireless power transfer end 10 and the wireless power reception end 20 may perform in-band communication in which information is exchanged using the same frequency band as the operating frequency used for wireless power transfer.

In another example, the wireless power transfer end 10 and the wireless power reception end 20 may perform out-of-band communication in which information is exchanged using the frequency band different from the operating frequency used for wireless power transfer.

For example, the information exchanged between the wireless power transfer end 10 and the wireless power reception end 20 may include status information of each other and control information. Here, the status information and the control information exchanged between the transmission end and the reception end may include information for identifying a category of a wireless power receiver, information for identifying the current power reception status of the wireless power receiver, information on whether an over-voltage protection function is installed, version information of software installed in the wireless power receiver, power control request information, and the like.

In-band communication and out-of-communication may provide bidirectional communication, but the embodiments are not limited thereto. In another embodiment, in-band communication and out-of-communication may provide a unidirectional communication or half duplex communication.

For example, unidirectional communication may, but is not limited to, mean transmission of information from the wireless power reception end 20 to the wireless power transfer end 10 or transmission from the wireless power transfer end 10 to the wireless power reception end 20.

The half duplex communication method is characterized in that bidirectional communication between the wireless power reception end 20 and the wireless power transfer end 10 is enabled but information can be transmitted only by one device at a certain point in time.

The wireless power reception end 20 according to the embodiment may acquire a variety of status information of the electronic apparatus 30. For example, the status information of the electronic apparatus 30 may include, but is not limited to, current power usage information, current power usage information, information for identifying an executed application, CPU usage information, battery charge status information, battery output voltage/current information, etc. and may include information capable of being acquired from the electronic apparatus 30 and being used for wireless power control.

In particular, the wireless power transfer end 10 according to the embodiment may transmit a predetermined packet indicating whether fast charging is supported to the wireless power reception end 20. The wireless power reception end 20 may inform the electronic apparatus 30 that the wireless power transfer end 10 supports the fast charging mode, upon determining that the wireless power transfer end 10 supports the fast charging mode. The electronic apparatus 30 may display information indicating that fast charging is possible through a predetermined display means, for example, a liquid crystal display.

In addition, the user of the electronic apparatus 30 may select a predetermined fast charging request button displayed on the liquid crystal display means and control the wireless power transmission end 10 to operate in the fast charging mode. In this case, when the user selects the fast charging request button, the electronic apparatus 30 may transmit a predetermined fast charging request signal to the wireless power reception end 20. The wireless power reception end 20 may generate and transmit a charging mode packet corresponding to the received fast charging request signal to the wireless power transmission end 10, thereby switching a normal low-power charging mode to the fast charging mode.

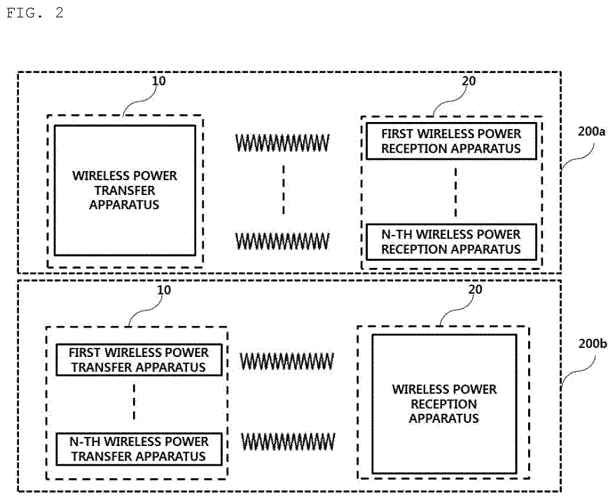

FIG. 2 is a block diagram illustrating a wireless charging system according to another embodiment.

For example, as denoted by reference numeral 200a, the wireless power reception end 20 may include a plurality of wireless power reception apparatuses, which are connected to one wireless power transfer end 10 to perform wireless charging. At this time, the wireless power transfer end 10 may divide and transfer power to the plurality of wireless power reception apparatuses in a time-divisional manner but is not limited thereto. In another example, the wireless power transfer end 10 may divide and transfer power to the plurality of wireless power reception apparatus using different frequency bands respectively allocated to the wireless power reception apparatuses.

At this time, the number of wireless power reception apparatuses connectable to one wireless power transfer apparatus 10 may be adaptively determined based on at least one of the required power amount of each wireless power reception apparatus, a battery charge state, power consumption of the electronic apparatus and available power amount of the wireless power transfer apparatus.

In another example, as denoted by reference numeral 200b, the wireless power transfer end 10 may include a plurality of wireless power transfer apparatuses. In this case, the wireless power reception end 20 may be simultaneously connected to the plurality of wireless power transfer apparatuses and may simultaneously receive power from the connected wireless power transfer apparatuses to perform charging. At this time, the number of wireless power transfer apparatuses connected to the wireless power reception end 20 may be adaptively determined based on the required power amount of the wireless power reception end 20, a battery charge state, power consumption of the electronic apparatus, and available power amount of the wireless power transfer apparatus.

In accordance recent trends, a wireless charging system is used in a building such as a home or an office space and is also installed and used in a vehicle. A wireless charging system installed in a vehicle may be used to charge a portable device of a passenger including a driver.

An antenna for short-distance wireless communication may also be installed in the wireless power transmitter installed in the vehicle. According to an embodiment, short-distance wireless communication may be near field communication (NFC) but may include Bluetooth communication, beacon communication, ZigBee communication, WiFi communication, or the like.

The wireless power transmitter installed in the vehicle may perform short-distance wireless communication with a portable device of a user and may perform various functions. In some embodiments, the wireless power transmitter installed in the vehicle may perform a financial payment service (e.g., a high-pass service or a refueling payment service) which occurs during vehicle traveling through short-distance wireless communication with a portable service. The wireless power transmitter may use a remote wakeup service of a vehicle through short-distance wireless communication with a portable service and may check whether there is access authorization for traveling as a vehicle driver. In addition, position information of the vehicle may be transmitted to the portable service using the wireless power transmitter as a medium such that the user checks a position of the vehicle.

According to an embodiment, the wireless power transmitter may transmit a payment request signal to the portable service through short-distance wireless communication, and the portable service may transmit a response signal thereto.

According to an embodiment, the portable service may transmit a remote wakeup signal to the wireless power transmitter through short-distance wireless communication. According to an embodiment, the wireless power transmitter may transmit a signal including position information of a vehicle to the portable service. In addition, according to an embodiment, the wireless power transmitter may transmit a control signal corresponding to various operations using short-distance wireless communication.

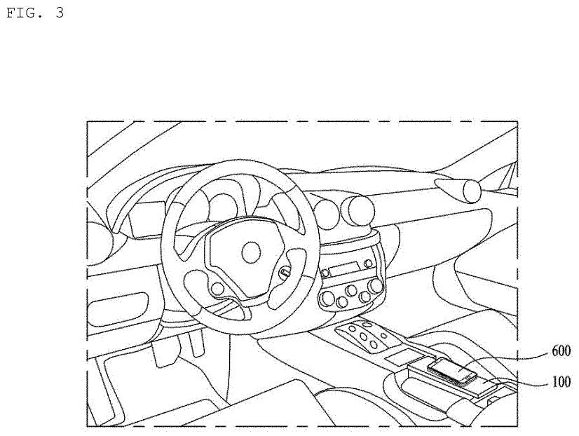

FIG. 3 is a diagram for explanation of a problem in terms of electromagnetic interference (EMI) that occurs during wireless charging in a vehicle.

As shown in FIG. 3, a wireless power transmitter 100 may be installed at one internal side of the vehicle. The wireless power transmitter 100 may generate an AC power signal using a power source in the vehicle, may wirelessly transmit the AC power signal through a transmission coil included in the wireless power transmitter 100, and may charge the wireless power receiver 600 disposed on a charging bed.

An audio video navigation (AVN) system installed at one side of a vehicle center fascia may be connected to an antenna installed inside/outside the vehicle. A passenger in the vehicle may listen to a radio or may watch TV broadcast using radio wave received through the antenna installed inside/outside the vehicle.

When charging between the wireless power transmitter 100 and the wireless power receiver 600 begins, the wireless power transmitter may generate an AC power signal in an operation frequency band and may wirelessly transmit the AC power signal through a transmission coil. In this case, a harmonic component as well as the AC power signal may be output. In this case, some harmonic components may correspond to a FM/AM radio frequency band or(and) a TV watching frequency band. In this case, the corresponding harmonic component may act as interference to a radio reception signal or(and) a TV reception signal and may degrade radio listening sensitivity or(and) TV reception sensitivity.

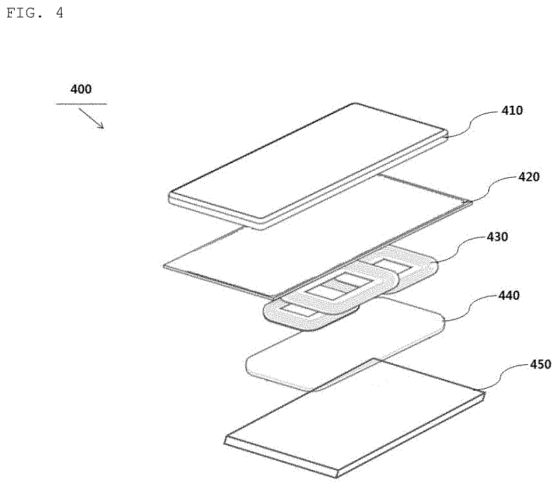

FIG. 4 is an exploded perspective view of a wireless charging device (hereinafter, a wireless power transmitter) according to an embodiment.

Referring to FIG. 4, a wireless power transmitter 400 may include a charging bed 410, a first substrate 420 (hereinafter, an antenna substrate), a coil assembly 430 (hereinafter, a transmission coil assembly), a second substrate 440 (hereinafter, a shield member), and a control circuit substrate 450.

An NFC antenna may be disposed on a first surface of the antenna substrate 420, and an EMI filter may be disposed on a second surface. Here, the first surface may be a surface that contacts the transmission coil assembly 430, and the second surface may be a surface that contacts the charging bed 410, but the embodiments is not limited thereto.

The antenna substrate 420 may be conductibly connected to the control circuit substrate 450.

An NFC antenna and an EMI filter may be disposed on one surface and the other surface of the antenna substrate 420, respectively. For example, the NFC antenna and the EMI filter may be pattern-printed on the antenna substrate 420. In this case, the NFC antenna and the EMI filter may be pattern-printed on a corresponding surface of the antenna substrate 420 not to overlap with each other.

For example, the EMI filter may be embodied to block a frequency signal that exceeds an operation frequency band for wireless charging. For example, the operation frequency band may be 110 kHz to 205 kHz, but the embodiments are not limited thereto and the operation frequency band may be changed according to standard applied to the wireless power transmitter.

For example, when the NFC antenna is a loop antenna, the EMI filter may be disposed within a loop of the NFC antenna. In addition, the NFC antenna and the transmission coil assembly 430 may be disposed not to overlap with each other. The transmission coil assembly 430 according to an embodiment may include a plurality of coils and adjacent coils may partially overlap each other. For example, as shown in FIG. 4, the transmission coil assembly 430 may include three coils and adjacent coils may partially overlap each other.

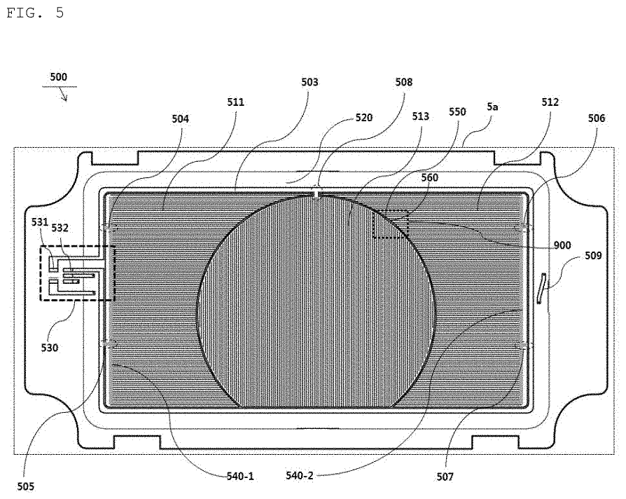

The form of the EIM filter will be described below in detail with reference to FIG. 5.

The shield member 440 may prevent electromagnetic wave generated by the transmission coil assembly 430 from being transmitted to the control circuit substrate 450. The shield member 440 may include a heat dissipation structure for dissipating heat generated by the transmission coil assembly 430.

The shield member 440 may further include an accommodation unit (not shown) for accommodating the transmission coil assembly 430. Here, the accommodation unit may be formed of the same material as the shield member 440 or may be formed of a different material therefrom.

For example, the shield member 440 and accommodation unit may be configured as a sendust block that is integrally injection-molded. In another example, the shield member 440 may be embodied in the form of a metallic plate to which a ferrite-based shield sheet and(or) shield sheet are attached, and the accommodation unit may be molded from a plastic resin and may be coupled to the metallic plate.

The shield member 440 may include a terminal disposed at one end, and may be connected to opposite ends of a coil of the transmission coil assembly 430. Needless to say, the transmission coil assembly 430 may be conductibly connected to the control circuit substrate 450 through the corresponding terminal.

The control circuit substrate 450 may include a power converter for converting external power into an AC power signal for wireless charging.

The control circuit substrate 450 may include a modulator and a demodulator for in-band or(and) out-band communication with a wireless power receiver.

The control circuit substrate 450 may also include a sensing circuit for measuring voltage, current, temperature, or the like at a specific position in the wireless power transmitter 400.

The control circuit substrate 450 may include a controller for control of an overall operation of the wireless power transmitter 400. Here, the controller may be embodied in the form of a microprocessor, a digital signal processor (DSP), or an ASIC and may interwork with a memory for storing a program and various data, but the form of the controller is not limited thereto.

The control circuit substrate 450 may include an NFC processing processor for processing an NFC signal.

The transmission coil assembly 430 may include a plurality of transmission coils with a step difference, and the form of the electromagnetic interference filter disposed on one surface of the antenna substrate 420 may be determined based on the step difference.

For example, the electromagnetic interference filter may include a wiring connected to a ground terminal and a plurality of pattern filters branched from the corresponding wiring. In this case, a slit direction of a pattern filter may be changed according to the step difference of the transmission coil. For example, slit directions of pattern filters with different step differences may be disposed to each other.

FIG. 5 is a diagram for explanation of a structure of a first surface of an antenna substrate according to an embodiment.

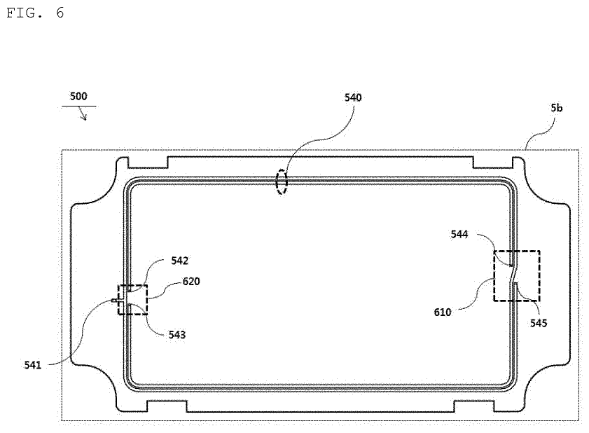

An electromagnetic interference filter—hereinafter referred to as an EMI filter for convenience of description—may be disposed on a first surface 5a of an antenna substrate 500 according to an embodiment, and a short-distance wireless communication antenna may be disposed on a second surface 5b to be described below with reference to FIG. 6.

Here, the short-distance wireless communication antenna may include a near field communication (NFC) antenna, a radio frequency identification (RFID) communication antenna, a magnetic security transfer (MST) antenna, or the like, but hereinafter, an example in which a short-distance wireless communication antenna is an NFC communication antenna will be described.

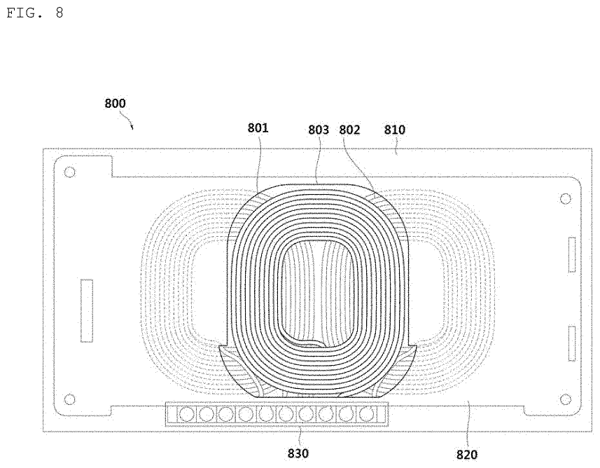

In the following embodiments, as described below with reference to FIG. 8, first to third coils 801, 802, and 803 may be installed in the wireless power transmitter, and three coil wireless power transmitters including a transmission coil assembly in which two adjacent coils partially overlap each other will be exemplified.

Referring to FIG. 5, the first surface 5a of the antenna substrate 500 may broadly include a first wiring 503 with a loop shape, a first pattern filter 511 and a second pattern filter 512 which are branched from one side of the first wiring 503, have a slit structure with a shape of the teeth of a comb, and are disposed in the first pattern region, and a third pattern filter 513 and a connection terminal 530 that are disposed in the second pattern region. Here, it may be noted that the first to third pattern filters 511, 512, and 513 are conductibly connected to each other through the first wiring 503.

A slit arrangement form of the third pattern filter 513 disposed in the center of the first surface 5a may be different from a slit arrangement form of the first pattern filter 511 and the second pattern filter 512. For example, as shown in FIG. 5, a slit arrangement direction of the third pattern filter 513 and a slit arrangement direction of the first pattern filter 511 and the second pattern filter 512 may be designed to be orthogonal to each other.

The third pattern filter 513 may be disposed to correspond to the form or external circumference of the first transmission coil 801 disposed at an upper end of the center in the transmission coil assembly having the three coil structure of FIG. 8 below.

For example, the third pattern filter 513 may be designed to be larger than the external circumference of the first transmission coil 801 and to be disposed within the loop of the first wiring 503. Needless to say, the first pattern filter 511 and the second pattern filter 512 may also be designed to be disposed within the loop of the first wiring 503.

The first pattern region may have a first slit structure and the second pattern region may have a second slit structure.

The first slit structure may include a plurality of spaced wirings and the plurality of spaced wirings may have different lengths.

The second slit structure may have a plurality of spaced wirings and the plurality of spaced wirings may have different lengths.

With reference to FIG. 8 described below, the third coil 803 disposed in a central portion and the first coil 801 and the second coil 802 disposed at a side surface may have different coil lengths, and accordingly, transmission coils disposed at the center and the side surface may have different inductance values.

In consideration of different inductance values of coils, the first pattern region and the second pattern region may also have different inductance values, shapes, and lengths, and thus an effect of shielding electromagnetic interference may be optimized.

In consideration of different positional relationships of coils, the first pattern region and the second pattern region may also have different inductance values, shapes, and lengths, and thus an effect of shielding electromagnetic interference may be optimized.

An area of the first pattern region may be smaller than an area of a portion on which the first coil 801 or the second coil 802 is disposed.

An area of the second pattern region may be larger than an area of a portion on which the third coil 803 is disposed. Thus, an electromagnetic wave generated from the third coil 803 disposed in the center to contact the second substrate may be effectively blocked.

With reference to FIG. 5 above and FIG. 6 below, an NFC antenna 540 may be disposed on the second surface 5b of the antenna substrate 500 along the external circumference of the first wiring 503 shaped like a loop. It may be noted that an NFC antenna 540 is actually disposed in a corresponding area of the second surface 5b corresponding to reference numeral 520—hereinafter, an NFC antenna region 520 for convenience of description—of the first surface 5a.

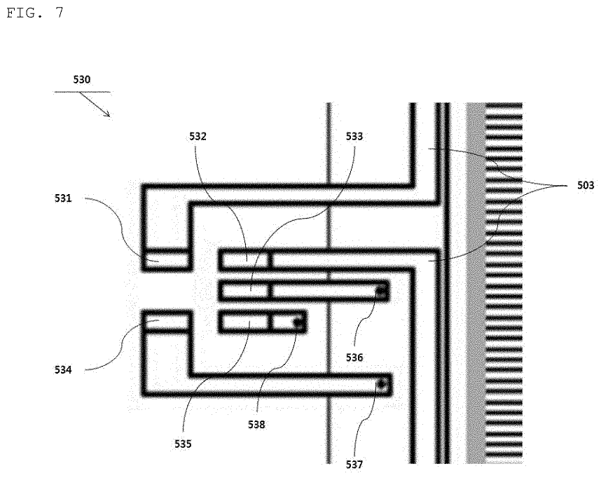

However, when the NFC antenna 540 has a plurality of winding wirings, one end 542 and the other end 543 of the NFC antenna 540 may be conductibly connected to the corresponding terminals of the connection terminal 530 of FIG. 7 below through a through hole or a via hole. To this end, a partial section 509 of the winding wiring of the NFC antenna 540 may be designed to be disposed in the NFC antenna region 520 of the first surface 5a. Opposite ends of the partial section 509 of the winding wiring of the NFC antenna 540 may be connected to reference numerals 544 and 545 of FIG. 6 below through the through hole or the via hole.

First to fifth connection structures 504, 505, 506, 507, and 508 for conductibly connecting the first wiring 503 and the pattern filters 511, 512, and 513 to each other may be disposed on the first surface 5a.

Here, the number and positions of connection structures disposed on the first surface 5a for conductibly connecting the first wiring 503 and each pattern filter to each other may be changed according to the purpose of design of one of ordinary skill in the art.

Referring to FIG. 5, the first pattern filter 511 may be connected to the first wiring 503 through the first to second connection structures 504 and 505 and a second connection wiring 540. Current flowing in the first pattern filter 511 may be uniformly distributed in each slit through the first to second connection structures 504 and 505 and a second connection wiring 540-1.

The second pattern filter 512 may be connected to the first wiring 503 through the third and fourth connection structures 506 and 507 and a second connection wiring 540-2. Current flowing in the second pattern filter 512 may be uniformly distributed in each slit through the third and fourth connection structures 506 and 507 and the second connection wiring 540-2.

The third pattern filter 513 may be connected to the first wiring 503 through the fifth connection structure 508 and a third connection wiring 550. Current flowing in the third pattern filter 513 may be uniformly distributed in each slit through the fifth connection structure 508 and the third connection wiring 550.

The second connection wirings 540-1 and 540-2 may be shaped like a straight line. Accordingly, an electromagnetic interference filter may be disposed not to overlap an NFC antenna disposed on the second surface.

The third connection wiring 550 may be shaped like a curve line. Accordingly, the third connection wiring 550 may be disposed in consideration of shapes and arrangement relationship between an electromagnetic interference filter and a coil module.

A spaced unit 560 may be disposed between the first pattern region and the second pattern region that are differentiated from the third pattern region through the third pattern region and the third connection wiring 550. Each pattern or pattern filter may be identified by the spaced unit 560, and an optimized electromagnetic interference filter may be formed according to a coil shape.

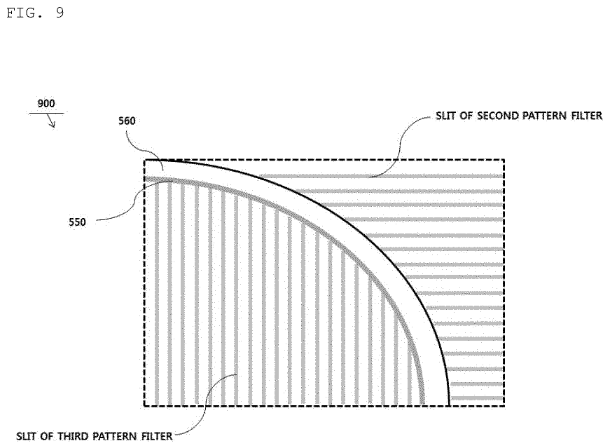

An arrangement structure 900 of the spaced unit 560 that forms a boundary of different patterns is illustrated in detail in FIG. 9.

One end and the other end of the first wiring 503, which are disposed adjacent to each other, may be connected to a first terminal 531 and a second terminal 532 of the connection terminal 530, respectively. For example, both the first terminal 531 and the second terminal 532 may be connected to ground.

A detailed configuration of the connection terminal 530 disposed on the first surface 5a of the antenna substrate 500 will be described in detail with reference to FIG. 7.

FIG. 6 is a diagram for explanation of a structure of a second surface of an antenna substrate according to an embodiment.

Referring to FIG. 6, the NFC antenna 540 shaped like a loop may be disposed on the second surface 5b of the antenna substrate 500. The NFC antenna 540 may include a plurality of winding wirings.

For example, as shown in FIG. 6, when a turn number of the NFC antenna 540 is 2, two turns may be disposed to cross each other in a partial section, as shown in reference numeral 610.

As described above with reference to FIG. 5, reference numerals 544 and 545 may be conductibly connected to each other by the wiring 509 disposed on the first surface 5a.

Accordingly, as shown in reference numeral 620, one end 542 and the other end 543 of the NFC antenna 540 are advantageously disposed on lines with the same turn. Here, one end 542 may be connected to a third terminal 533 of FIG. 7 below through a through hole or a via hole, and the other end 543 may be connected to a fourth terminal 534 of FIG. 7 below through a through hole or a via hole.

For example, NFC communication may use a differential manchester encoding method. In this case, the third terminal 533 and the fourth terminal 534 may be connected to positive and negative signal terminals, respectively, but the embodiments are not limited and the converse may also be possible.

A terminal branched from one side of the outermost turn of the NFC antenna 540—hereinafter, referred to as a branch terminal 541 for convenience of description—may be connected to a fifth terminal 535 of FIG. 7 below through a through hole or a via hole. Here, the fifth terminal 535 may be connected to a ground terminal included in the control circuit substrate 450.

FIG. 7 is a diagram for explanation of a structure of a connection terminal disposed on an antenna substrate according to an embodiment.

The connection terminal 530 according to an embodiment may be disposed at one side of the first surface 5a on which the pattern filter is disposed, as in the above embodiment of FIG. 5.

Each terminal included in the connection terminal 530 may be conductibly connected to the control circuit substrate 450 and a corresponding terminal included therein.

As shown in FIG. 7, the connection terminal 530 may include first to fifth terminals 531, 532, 533, 534, and 535.

The first terminal 531 and the second terminal 532 may be connected to one end and the other end of the first wiring 503, respectively. Both the first terminal 531 and the second terminal 532 may be connected to a ground terminal included in the control circuit substrate 450.

The third terminal 533 and the fourth terminal 534 may be connected to one end 542 and the other end 543 of the NFC antenna 540 through a first through hole 536 and a second through hole 537, respectively.

When a differential manchester encoding method is applied to NFC communication, the third terminal 533 and the fourth terminal 534 may be connected to positive and negative signal terminals included in the control circuit substrate 450, respectively, but the embodiments are not limited and the converse may also be possible.

The fifth terminal 535 may be connected to the branch terminal 541 branched from an intermediate portion of a winding wiring of the NFC antenna 540 through a third through hole 538. For example, the branch terminal 541 may be branched at one side of the outermost turn of the NFC antenna 540, but a branched position is not particularly limited.

The fifth terminal 535 may be connected to a ground terminal included in the control circuit substrate 450.

FIG. 8 is a diagram for explanation of a structure of a coil assembly (hereinafter, a transmission coil assembly) according to an embodiment.

Referring to FIG. 8, a transmission coil assembly 800 may include a first coil 801, a second coil 802, a third coil 803, a substrate 810, an accommodation unit 820, and a connection terminal 830.

The connection terminal 830 may be disposed at one side of the substrate 810 and may be conductibly connected to the control circuit substrate 450.

As shown in FIG. 8, the first coil 801 and the second coil 802 may be disposed adjacent to each other in a central portion of the substrate 810, and the third coil 803 may be disposed above the first coil 801 and the second coil 802.

In this case, the third coil 803 may be disposed to overlap a partial region of the first coil 801 and the second coil 802. The third coil 803 disposed on the substrate 810, and the first coil 801 band and the second coil 802 that are respectively disposed on opposite surfaces of the third coil 803 may have different heights from the substrate 810.

That is, a step difference may be formed between the third coil 803, and the first coil 801 and the second coil 802. In order to compensate for coupling characteristics due to the step difference, the length of a winding wiring of the third coil 803 and the length of a winding wiring of the second coil 802 may be differently designed.

In this case, the impedance characteristic of the third coil 803 and the impedance characteristic of the first coil 801 and the second coil 802 may be different from each other due to the step difference, and accordingly, the high frequency properties in the third coil 803 may be different from the high frequency properties in the remaining first coil 801 and second coil 802. As shown in FIG. 5 above, a shape of a pattern filter and a direction of a slit may be differently designed at the center and the side surface.

As shown in FIG. 8, the accommodation unit 820 may be injection-molded of plastic to accommodate a transmission coil, but this is merely an embodiment, and the substrate 810 and the accommodation unit 820 may also be configured as a sendust block that is integrally injection-molded. An accommodation groove for accommodating the connection terminal 830 may also be disposed at one side of the sendust block.

The wireless charging device according to an embodiment may include a wireless power transmitter or a wireless power receiver.

The wireless charging device according to an embodiment may include a coil assembly, a first substrate disposed on the coil assembly, an electromagnetic interference filter disposed on a first surface of the first substrate, and a wireless communication antenna disposed on a second surface of the first substrate, the coil assembly may include a plurality of coils, and the electromagnetic interference filter may include a plurality of different pattern regions corresponding to the plurality of coils.

The coil assembly according to an embodiment may include a first coil, a second coil, and a third coil, the first coil and the second coil may be disposed on a second substrate, the third coil may be disposed on the first coil and the second coil, and the plurality of different pattern regions may include a first pattern region corresponding to the first coil or the second coil, and a second pattern region corresponding to the third coil.

The electromagnetic interference filter according to an embodiment may include a first wiring disposed in the form of a loop on the second surface.

The first pattern region according to an embodiment may be connected through a first connection structure positioned at opposite regions of the first wiring, and the second pattern region may be connected through a second connection structure positioned at a central region of the first wiring.

The first connection structure according to an embodiment may be configured in a plural number.

The first pattern region according to an embodiment may include a second connection wiring connected to the first connection structure, the second pattern region may include a third connection wiring connected to the second connection structure, and the third wiring may have a smaller width than the first wiring or the second wiring.

The first pattern region according to an embodiment may include a first slit structure that is disposed in a first direction in the second connection wiring, and the second pattern region may include a second slit structure that is disposed in a second direction in the third connection wiring.

According to an embodiment, the first direction and the second direction may be different from each other.

According to an embodiment, the first direction and the second direction may be orthogonal to each other.

The first pattern region according to an embodiment may be disposed to be spaced apart from the first coil or the second coil, and the second pattern region may be disposed to contact the third coil.

According to an embodiment, the first pattern region and the second pattern region may have different inductance values.

According to an embodiment, an area of the first pattern region may be smaller than an area of a portion on which the first coil or the second coil is disposed.

According to an embodiment, an area of the second pattern region may be larger than an area of a portion on which the third coil is disposed.

According to an embodiment, the first pattern region and the second pattern region may have different areas.

According to an embodiment, the first pattern region and the second pattern region may have different shapes.

According to an embodiment, the second pattern region may be disposed between two first pattern regions.

According to an embodiment, a spaced unit may be disposed between the first pattern region and the second pattern region.

The second connection wiring according to an embodiment may be shaped like a straight line, and the third connection wiring may be shaped like a curve line.

The first slit structure according to an embodiment may include a plurality of spaced wirings, and the plurality of spaced wirings may have different lengths.

The second slit structure according to an embodiment may include a plurality of spaced wirings, and the plurality of spaced wirings may have different lengths.

According to an embodiment, a width of the first connection structure may be smaller than a width of the second connection structure.

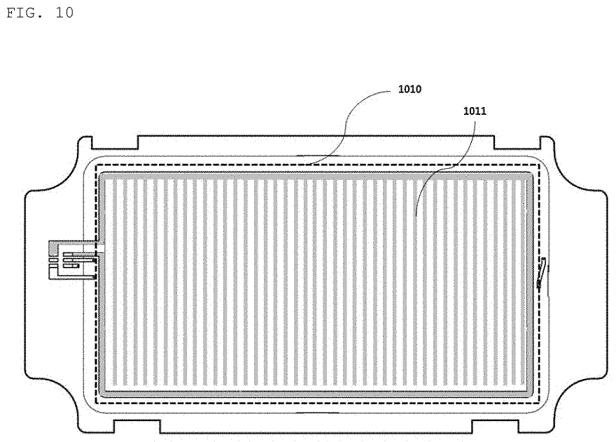

FIG. 10 is a diagram showing a substrate on which an electromagnetic interference filter is installed according to the related art.

As shown in FIG. 10, a conventional electromagnetic interference filter 1010 may be configured in such a way that all slits 1011 included in the electromagnetic interference filter 1010 are disposed in the same direction irrespective of arrangement of coils disposed on a coil assembly and a height difference from a bottom surface of a substrate included in the coil assembly.

Here, as described above with reference to FIG. 8, the height difference of coils may be caused when the third coil 803 is disposed to overlap a partial region of the first coil 801 and the second coil 802.

In this case, the third coil 803 disposed at an upper end of the substrate 810, and the first coil 801 and the second coil 802 that are disposed at opposite sides of a lower end of the third coil 803 may have different impedance characteristic and high frequency properties due to the step difference.

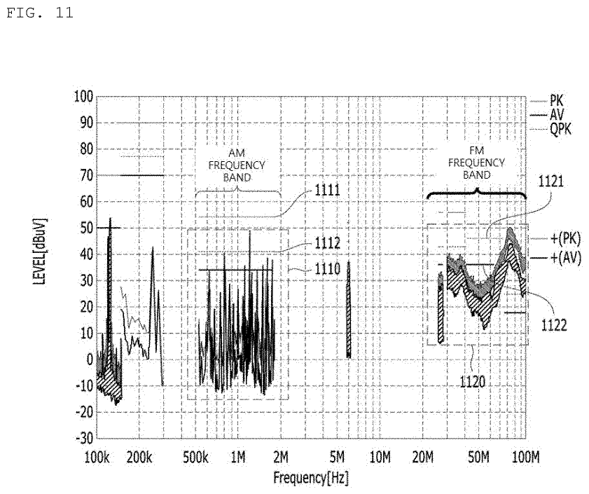

FIG. 11 is a graph showing an experimental result showing EMI shielding performance with respect to the electromagnetic interference filter of FIG. 10 above.

Reference numerals 1110 and 1120 of FIG. 11 show change pattern of a peak value and an average value of electromagnetic waves measured in an AM frequency band and an FM frequency band, respectively.

As seen from reference numeral 1110 of FIG. 11, the conventional electromagnetic interference filter without consideration of arrangement of coils and the step difference may have EMI shield performance in the AM frequency band, which satisfies peak references (PK), 1211 but does not satisfy average reference (AV) 1212. Here, when a measured value is smaller than a corresponding reference, it may be determined that EMI shield performance in the corresponding frequency band satisfies the reference, and when the measured value is greater than the corresponding reference, it may be determined that EMI shield performance in the corresponding frequency band satisfies the reference.

As seen from reference numeral 1120 of FIG. 11, the electromagnetic interference filter of FIG. 10 does not satisfy a peak reference (PK) 1221 as well as an average value reference (AV) 1222 in the FM frequency band.

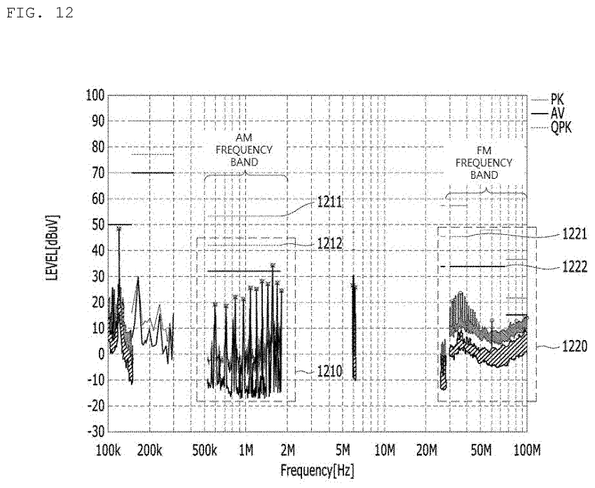

FIG. 12 is a graph showing EMI shield performance of the electromagnetic interference filter of FIG. 5 above.

Reference numerals 1210 and 1220 of FIG. 12 show change pattern of a peak value and an average value of electromagnetic waves measured in an AM frequency band and an FM frequency band, respectively.

As seen from reference numeral 1210 of FIG. 12, the electromagnetic interference filter to which a direction and pattern of a slit are applied in consideration of arrangement of coils and the step difference may satisfy a peak reference (PK) 1111 and an average reference (AV) 1112 in the AM frequency band.

As seen from reference numeral 1220 of FIG. 12, the electromagnetic interference filter in FIG. 5 above may also satisfy both an average reference (AV) 1122 and a peak reference (PK) 1121 in the FM frequency band.

Accordingly, it may be seen that a wireless charging device including an electromagnetic interference filter designed in consideration of arrangement of coils and the step difference has excellent EMI shield performance compared with the conventional electromagnetic interference filter without consideration of arrangement of coils and the step difference.

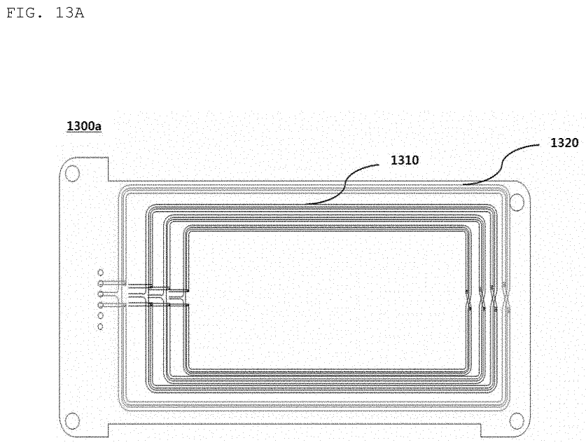

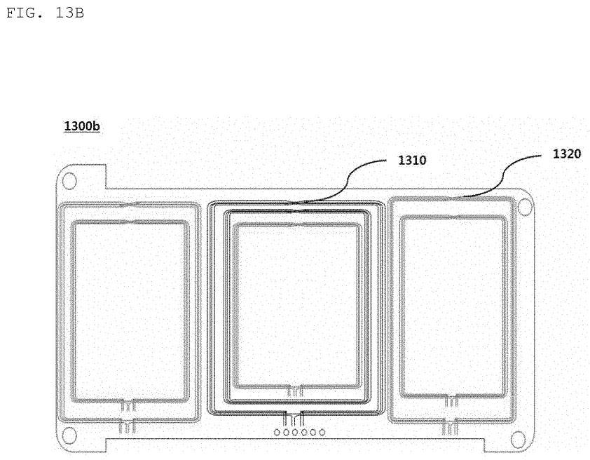

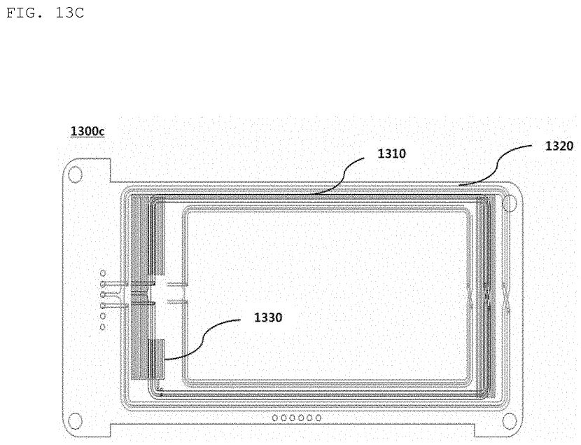

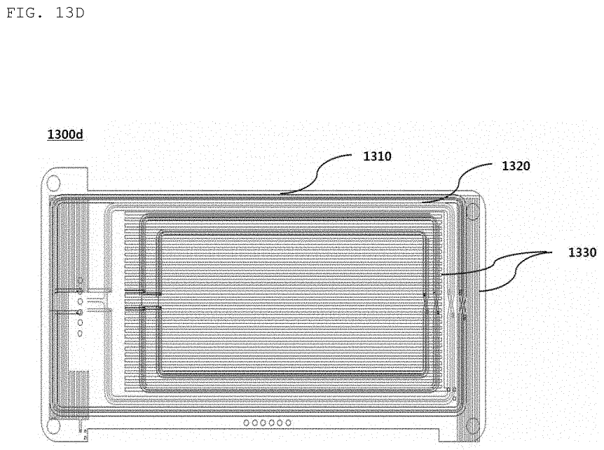

FIGS. 13A to 13D are diagrams for explanation of arrangement of a wireless power transmitter antenna and a short-distance wireless communication antenna according to an embodiment.

A wireless power transmitter antenna 1310 according to an embodiment is not limited to a wireless power transmission method. In other words, the wireless power transmitter antenna may receive power using at least one of an electromagnetic induction method, an electromagnetic resonance method, an RF wireless power transmission method, or other wireless power transmission methods.

The wireless power transmitter antenna according to an embodiment is not limited by various wireless power transmission standards to which the same wireless power transmission method is applied. In other words, a wireless power antenna for receiving power using an electromagnetic induction method may receive power according to at least one standard of wireless power consortium (WPC) or/and power matters alliance (PMA). In addition, a wireless power antenna for receiving power using an electromagnetic resonance method may receive power using a resonance method defined in the alliance for wireless power (A4WP) standard organization.

The embodiments are based on the fact that a short-distance wireless communication antenna 1320 is affected by transmission and reception of a signal due to a magnetic field, a power signal, or an RF signal for wireless power transmission. Accordingly, with regard to arrangement of the short-distance wireless communication antenna 1320 and the wireless power transmitter antenna 1310, an embodiment may include any arrangement as long as the short-distance wireless communication antenna 1320 is positioned in a region that is affected by radio interference from the wireless power transmitter antenna 1310. That is, the embodiments may include any arrangement as long as the short-distance wireless communication antenna 1320 is affected by wireless power transmission (e.g., power signal or power control signal) due to arrangement in which the short-distance wireless communication antenna 1320 and the wireless power transmitter antenna 1310 are disposed adjacent to each other.

In particular, an adjacent distance between the short-distance wireless communication antenna 1320 and the wireless power transmitter antenna 1310 may be increased when wireless power transmission is fast charging (e.g., when output voltage is 9 V and output current is 1.67 A) other than general charging (e.g., when output voltage is 5 V and output current is 2 A), and according to an embodiment, the adjacent distance between the short-distance wireless communication antenna 1320 and the wireless power transmitter antenna 1310 is not limited.

Referring to FIGS. 13A to 13D, the wireless power transmitter antenna 1310 and the short-distance wireless communication antenna 1320 may be disposed adjacent to each other. In some embodiments, the short-distance wireless communication antenna 1320 and the wireless power transmitter antenna 1310 may be disposed adjacent to each other but may be disposed not to overlap each other on the same plane. In some embodiments, the wireless power transmitter antenna 1310 and the short-distance wireless communication antenna 1320 may be disposed on different planes, and when disposed on different planes, the wireless power transmitter antenna 1310 and the short-distance wireless communication antenna 1320 may be disposed not to overlap each other viewed from the front of the wireless power transmitter. This is to alleviate influence on the short-distance wireless communication antenna 1320 due to the wireless power signal.

The number, size, and position of the short-distance wireless communication antennas 1320 may not be limited to FIGS. 13A to 13D.

When a control module (not shown) of the short-distance wireless communication antenna 1320 controls one short-distance wireless communication antenna 1320, a corresponding structure may be classified as a 1-WAY structure, and when one control module controls two short-distance wireless communication antennas 1320, a corresponding structure may be classified as a 2-WAY structure. In some embodiments, the number of control modules included in a wireless power transmitter may also correspond to the number of the short-distance wireless communication antenna 1320, and thus a plurality of 1-WAY structures. In order to expand a region which short-distance wireless communication is allowed (a region in which a short-distance wireless communication signal is capable of being transmitted and received), the plurality of short-distance wireless communication antennas 1320 and the plurality of control modules may be included in the wireless power transmitter.

As shown in FIG. 13A, one short-distance wireless communication antenna 1320 included in a wireless power transmitter 1300a may be disposed outside one the wireless power transmitter antenna 1310 on the same plane.

As shown in FIG. 13B, the short-distance wireless communication antenna 1320 included in a wireless power transmitter 300b may be configured in a plural number. The short-distance wireless communication antenna 1320 may be disposed adjacent to left and right sides on the same plane as the wireless power transmitter antenna 1310. The short-distance wireless communication antennas 1320 disposed at opposite side surfaces of the wireless power transmitter antenna 1310 may expand a recognition region of a short-distance wireless communication signal.

According to an embodiment, the wireless power transmitter antenna 1310 and the short-distance wireless communication antenna 1320 may be disposed to be spaced apart from each other on the same plane.

As shown in FIG. 13C, the plurality of short-distance wireless communication antennas 1320 may be disposed inside and outside the wireless power transmitter antenna 1310 included in a wireless power transmitter 1300c. According to the size of an antenna, the short-distance wireless communication antenna 1320 may be disposed inside and outside a wireless power antenna on the same plane and may be disposed on different planes.

The wireless power transmitter antenna 1310 may generate a wireless power signal, and as closer to a region in which the wireless power transmitter antenna 1310 is positioned, the intensity of the wireless power signal may be increased. The short-distance wireless communication antenna 1320 may be interfered by a wireless power signal during transmission and reception of the short-distance wireless communication signal.

In order to alleviate influence on the short-distance wireless communication antenna 1320 due to a wireless power signal generated from the wireless power transmitter antenna 1310 as an obstructive factor of short-distance wireless communication, an electromagnetic interference filter 1330 may be disposed to overlap a region in which the wireless power transmitter antenna 1310 is positioned.

As shown in FIG. 13D, the plurality of wireless power transmitter antennas 1310 may be disposed inside and outside the short-distance wireless communication antenna 1320.

Each of the plurality of wireless power transmitter antenna 1310 may generate a wireless power signal, and as as closer to a region in which the wireless power transmitter antenna 1310 is positioned, the intensity of the wireless power signal may be increased. Accordingly, the short-distance wireless communication antenna 1320 surrounded by the wireless power transmitter antenna 1310 may be interfered by a wireless power signal during transmission and reception of a short-distance wireless communication signal. As shown in FIG. 13C, the electromagnetic interference filter may be disposed to overlap the wireless power transmitter antenna 1310, and an antenna of the electromagnetic interference filter may also have different patterns according to the arrangement position and arrangement shape of wireless power transmitter antennas.

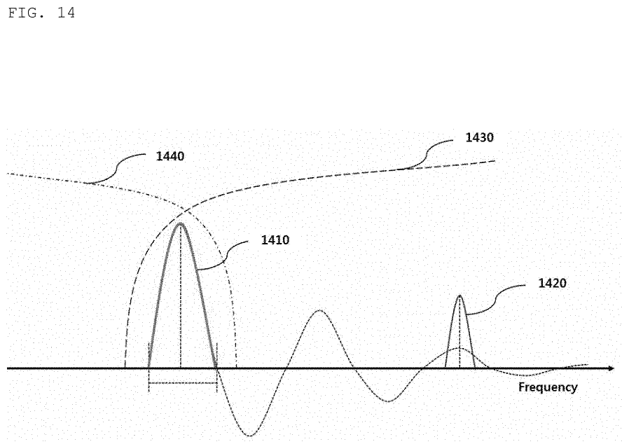

FIG. 14 is a diagram for explanation of a harmonic of a wireless power signal and a frequency band of a short-distance wireless communication signal according to an embodiment.

Referring to FIG. 14, there may be a frequency band in which a high frequency signal of a frequency band 1410 of a wireless power signal transmitted and received by a wireless power transmitter antenna and a frequency band 1420 of short-distance wireless communication overlap each other.

The wireless power signal may have a preset operation frequency according to a wireless power transmission method and standard specification of a wireless power transmitter antenna. Unlike in an ideal system, it may not be possible to input a pure sine wave and to process the pure sine wave without distortion. An actual system is not ideal, and thus both transmission and reception sides of a signal are not capable of transmitting and receiving a perfect sine wave, and radio waves present in public is approximately close to sine wave and is not a perfect sine wave, and thus harmonics may be basically mixed. In addition, a multiplication component may be present as the basic physical properties of a frequency, and a multiplication component that is not desired from a user viewpoint may act as noise, that is, an obstructive factor to an antenna of other communication systems. The multiplication component may be referred to as a multiplication frequency and may also be referred to as a harmonic.

The wireless power transmitter antenna may be set with different operation frequencies according to a wireless power transmission method, and in the case of an electromagnetic induction method, an operation frequency band of 125 kHz or 13.56 MHz may be set, in the case of an electromagnetic resonance method, an operation frequency band of several tens of kHz to several MHz may be set, and in the case of an RF wireless power transmission method, an operation frequency band of 2.45 GHz or 5.8 GHz may be set.

In some embodiments, a frequency band used in transmission and reception of a wireless power signal 1410 transmitted and received by a wireless power transmitter antenna may be defined as a first frequency band.

Short-distance wireless communication may be NFC communication, and NFC communication may use a frequency band of 13.56 MHz and may be a type of an electronic tag (RFID) for enabling rapid bidirectional communication between NFC devices. NFC communication may support bidirectional transmission and reception at a distance within 10 cm.

In some embodiments, a frequency band used in transmission and reception of a short-distance wireless communication signal 1420 transmitted and received by a short-distance wireless communication antenna may be defined as a second frequency band.

According to an embodiment, an electromagnetic interference filter included in a wireless power transmitter may block a harmonic of a wireless power signal and may remove an obstructive factor in communication of the short-distance wireless communication antenna.

The electromagnetic interference filter may include a first filter 1430 for passing a signal with a first cut-off frequency or greater, and a second filter 1440 for passing a signal with a second cut-off frequency or less.

The first filter may be a high pass filter for passing a signal with a first cut-off frequency or greater, and the second filter may be a low pass filter for passing a signal with a second cut-off frequency or less.

The electromagnetic interference filter may block a signal other than a pass band between the first cut-off frequency and the second cut-off frequency and may remove a high frequency signal other than the second cut-off frequency from the first cut-off frequency of the wireless power signal. Accordingly, the short-distance wireless communication signal 1420 may not be interfered by a high frequency of the wireless power signal 1410.

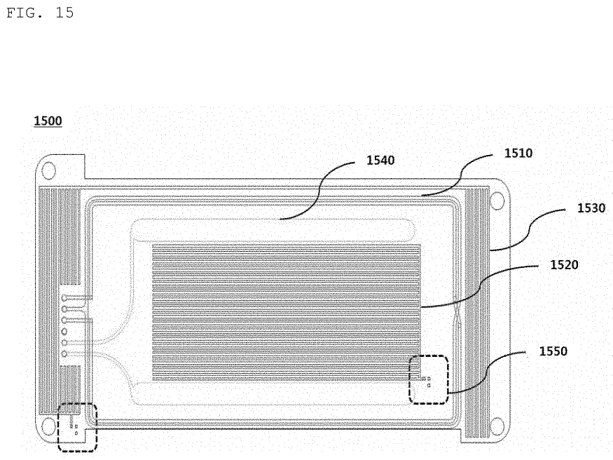

FIG. 15 is a diagram for explanation of an electromagnetic interference filter according to an embodiment.

Referring to FIG. 15, a wireless power transmitter 1500 may include a short-distance wireless communication antenna 1510, a first filter 1520 and a second filter 1530 included in an electromagnetic wave blocking filter, a capacitive sensing sensor 540 for detecting whether a wireless power receiver (not shown) is positioned on the wireless power transmitter 1500, and a matching circuit 1550 for controlling a frequency band blocked by the electromagnetic wave blocking filter. Components shown in FIG. 15 are not a requirement, and thus greater or fewer components than in FIG. 15 may constitute the wireless power transmitter 1500.

Any one of a first antenna of the first filter 1520 and a second antenna of the second filter 1530 may have a first pattern having a horizontal direction slit, and another one may have a second pattern having an orthogonal direction slit to a horizontal direction. According to orthogonality of the first antenna of the first filter 1520 and the second antenna of the second filter 1530, signals blocked by the first filter 1520 and the second filter 1530 may not be affected with each other and may independently block a hormonic of a wireless power signal.

The first antenna of the first filter 1520 and the second antenna of the second filter 1530 may have patterns with orthogonal directions, and the first antenna and the second antenna may be stacked on different layers without overlapping each other.

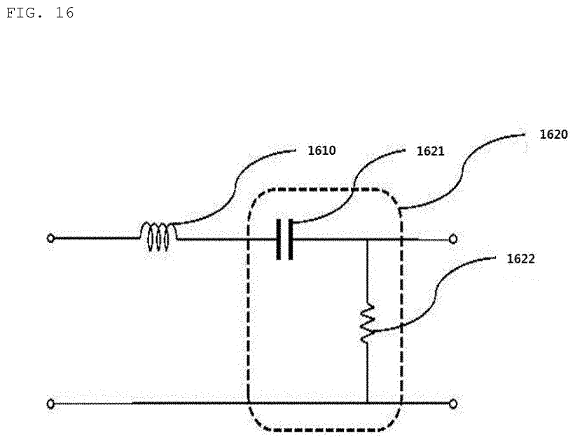

FIG. 16 is a diagram for explanation of a matching circuit of an electromagnetic interference filter according to an embodiment.

Referring to FIG. 16, the first antenna and the second antenna of the first filter and the second filter of FIG. 15 may be an inductor (L) 1610 that is an inductive device in an electromagnetic interference filter. A matching circuit 1620 may be an RLC resonance circuit and may include a capacitor (C) 1621 and a resistor (R) 1622.

A low pass filter and a high pass filter may have a cut-off frequency, and the cut-off frequency may be determined depending on a device value of each filter circuit. According to an embodiment, the cut-off frequency may be determined based on the length of the first and second antennas as an inductance device of a filter. In other words, each of the first antenna and the second antenna may have first and second lengths that are determined based on the first cut-off frequency and the second cut-off frequency, respectively.

The matching circuit 1620 may include a circuit in which the resistor (R) 1622 and the capacitor (C) 1621 are connected in series to each other, and may configure a low pass filter using voltage applied to the capacitor (C) 1621 as an output value. Simultaneously, in the circuit in which the resistor (R) 1622 and the capacitor (C) 1621 are connected in series to each other, a high pass filter may be configured using voltage applied to the resistor (R) 1622 as an ouptut value. In this case, a cut-off frequency (fc) may be 1/(2·π·R·C).

Those skilled in the art will appreciate that the disclosure may be carried out in other specific ways than those set forth herein without departing from the spirit and essential characteristics of the disclosure.

The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The embodiments may be used in wireless charging fields, and more particularly, may be applied to a wireless power transmitter with a structure for shielding an electromagnetic wave.

1.-10. (canceled)

11. A wireless charging device comprising:
a coil assembly;
a first substrate disposed on the coil assembly;
an electromagnetic interference filter disposed on a first surface of the first substrate; and
a wireless communication antenna disposed on a second surface of the first substrate, wherein the coil assembly includes a plurality of coils; and
wherein the electromagnetic interference filter includes a plurality of pattern regions corresponding to the plurality of coils, respectively.

12. The wireless charging device of claim 11, wherein the coil assembly includes a first coil, a second coil, and a third coil;
wherein the first coil and the second coil are disposed on a second substrate;
wherein the third coil is disposed on the first coil and the second coil; and
wherein the plurality of different pattern regions include a first pattern region corresponding to the first coil or the second coil and a second pattern region corresponding to the third coil.

13. The wireless charging device of claim 12, wherein the electromagnetic interference filter includes a first wiring disposed in a loop shape on the second surface.

14. The wireless charging device of claim 13, wherein the first pattern region is connected through first connection structure positioned in opposite regions of the first wiring; and
wherein the second pattern region is connected through a second connection structure positioned in a central region of the first wiring.

15. The wireless charging device of claim 14, wherein the first connection structure is configured in a plural number, and the first connection structure has a smaller width than a width of the second connection structure.

16. The wireless charging device of claim 14, wherein the first pattern region includes a second connection wiring connected to the first connection structure;
wherein the second pattern region includes a third connection wiring connected to the second connection structure; and
wherein the third connection wiring has a smaller width than the first wiring or the second connection wiring.

17. The wireless charging device of claim 16, wherein the first pattern region includes a first slit structure disposed in a first direction in the second connection wiring; and
wherein the second pattern region includes a second slit structure disposed in a second direction in the third connection wiring.

18. The wireless charging device of claim 17, wherein the first direction and the second direction are different from each other.

19. The wireless charging device of claim 17, wherein the first direction and the second direction are orthogonal to each other.

20. The wireless charging device of claim 12, wherein the first pattern region is disposed to be spaced apart from the first coil or the second coil; and
wherein the second pattern region is disposed to contact the third coil.

21. The wireless charging device of claim 12, wherein the first pattern region and the second pattern region have different inductance values.

22. The wireless charging device of claim 12, wherein the first pattern region has a smaller area than an area of a portion on which the first coil or the second coil is disposed.

23. The wireless charging device of claim 12, wherein the second pattern region has a larger area than an area of a portion on which the third coil is disposed.

24. The wireless charging device of claim 12, wherein the first pattern region and the second pattern region have different areas.

25. The wireless charging device of claim 12, wherein the first pattern region and the second pattern region have different shapes.

26. The wireless charging device of claim 12, wherein the second pattern region is disposed between the first pattern regions that correspond to the first coil and the second coil, respectively.

27. The wireless charging device of claim 12, wherein a spaced unit is disposed between the first pattern region and the second pattern region.

28. The wireless charging device of claim 16, wherein the second connection wiring is shaped like a straight line, and the third connection wiring is shaped like a curve shape.

29. The wireless charging device of claim 17, wherein the first slit structure includes a plurality of spaced wirings, and the plurality of spaced wirings have different lengths.

30. The wireless charging device of claim 17, wherein the second slit structure includes a plurality of spaced wirings, and the plurality of spaced wirings have different lengths.
